(19) United States
(12) Patent Application Publication
(10) Pub. No.: US 2013/0079066 A1
(43) Pub. Date: Mar. 28, 2013

(54) Mobile Device Support System, Apparatus and Method

(71) Applicant: Ying Chiu Chan, Vancouver (CA)

(72) Inventor: Ying Chiu Chan, Vancouver (CA)

(21) Appl. No.: 13/243,746

(22) Filed: Sep. 23, 2011

(51) Int. Cl. H04W 88/02

(52) U.S. Cl. 455/575.1

(57) ABSTRACT

A system and apparatus for supporting a mobile electronic device in vertical and horizontal orientations, the mobile device having a front with a viewing screen, a back, a top end, a bottom end, a left side and a right side, and a single, continuous frame affixed to the mobile device and having first, second, third and fourth pivots each located proximate to the top end, the bottom end, the left side and the right side, respectively. The frame is preferably formed of a rigid material such as metal or plastic that substantially maintains its shapes notwithstanding repeated deformation and is configured to bend away from the mobile device along the first and second pivot points and along the third and fourth pivot points while retaining its rectangular shape to support the mobile device in different orientations for a reasonable period of use.

### FIELD OF THE INVENTION

This invention relates generally to mobile electronic devices and, more particularly, to a system, apparatus and method for manipulating, utilizing and supporting such devices.

### BACKGROUND OF THE INVENTION

In recent years, the number of mobile electronic devices used by the typical person has dramatically increased. Smart phones, tablet computers, Internet/webpage viewers, electronic books, digital photo frames, electronic game consoles, media viewers/players and the like are ever present in today's society. Often a mobile electronic device, though mostly a self-contained unit, will require peripheral attachments to operate in the most protected, efficient and effective manner, such as mobile device cases, covers, carrying straps or handles and stands. In addition, virtually all mobile devices include a screen that allows users to view media, prompting a further need for the ability to position the screen at an optimal viewing angle given the circumstances of the user. For example, vertical or portrait format viewing is typically preferred in viewing portrait photographs, a complete page of a document, an electronic book or for participation in video conferencing. In contrast, horizontal or landscape format viewing is typically preferred in viewing photos in landscape format, a movie/video clip, to view a webpage or zoom into a portion of a document in order to maximize screen utilization or to play certain games.

Users can hold the mobile device vertically or horizontally to accomplish such varied viewing. However, holding mobile devices for extended periods of time is neither ergonomic nor convenient. Efforts to date to address this issue have been only marginally successful or have been accompanied by disadvantages, for example, resulting in increased complexity of operation and adding substantial weight and size to the mobile device. As on example, using a traditional photo frame configuration, a flap element is mounted at the back of the frame at an angle with a single hinge. The different adjacent edges of the flap acts as the essential anchor point against the supporting surface allowing the frame to stand in one vertical position or one horizontal orientation. Such configuration requires the flap edge to be located at the far left or far right side of the frame. As a result, the frame is highly unstable. Moreover, when the flap is not in use it protrudes from the back of the devices, creating an obstructive susceptible to interference, for example, catching on a protrusion from the environment.

In another example, an independent stand allows the user to freely rotate the device and configure it in either a vertical or horizontal orientation. Such stands, however, typically constitute an additional piece that must be carried and is subject to being misplaced or otherwise lost, in addition to creating additional bulk. Such independent stands are also traditionally inefficient as they require separate setup and takedown.

In another example, built-in multiple support elements are used. These support elements are built into the device or detachable holster/shell of the device. Each element is typically configured to unfold to support the mobile device in a specific orientation; for example, one leg opens to support the device to stand in vertical orientation while another leg opens to support the device to stand in horizontal orientation. Such designs are often confusing and complicated to use and are bulky.

In yet another example, a built-in single adjustable support element is used. This support element is built into the device or detachable holster/shell of the device. The single element supports the device for both vertical and horizontal orientations. The user is typically required to manually adjustment the support element to achieve the required orientation, such as by twisting, turning, pulling, pushing or sliding out the element or associated levers, either singling or in combination. Again, such designs readily become confusing and complicated to use and time consuming to set up and take down.

### SUMMARY OF THE INVENTION

An apparatus for supporting a mobile electronic device in vertical and horizontal orientations, the mobile device having a front with a viewing screen, a back, a top end, a bottom end, a left side and a right side, and a single, continuous frame affixed to the mobile device and having first, second, third and fourth pivots each located proximate to the top end, the bottom end, the left side and the right side, respectively. The frame is preferably formed of a rigid material such as metal or plastic that substantially maintains its shapes notwithstanding repeated deformation and is configured to bend away from the mobile device along the first and second pivot points and along the third and fourth pivot points while retaining its rectangular shape to support the mobile device in different orientations for a reasonable period of use.

A system for supporting a mobile electronic device in vertical and horizontal orientations, the mobile device having a front with a viewing screen and a back, and a frame having first, second, third and fourth elements and first, second, third and fourth pivots movably connected between the frame elements. The first pivot connects the first and second elements, the second pivot connects the third and fourth elements, the third pivot connect the second and fourth elements, and the fourth pivot connects the first and third elements. The frame is affixed to the mobile device to allow for pivotal movement of the frame in each of the following ways: movement of the first and second elements away from the back of the mobile device along the third and fourth pivots to facilitate maintaining the mobile device in a vertical orientation when place on a viewing surface; movement of the third and fourth elements away from the back of the mobile device along the third and fourth pivots to facilitate maintaining the mobile device in a vertical orientation when place on a viewing surface; movement of the first and third elements away from the back of the mobile device along the first and second pivots to facilitate maintaining the mobile device in a horizontal orientation when place on a viewing surface; and movement of the second and fourth elements away from the back of the mobile device along the first and second pivots to facilitate maintaining the mobile device in a horizontal orientation when place on a viewing surface.

Alternative embodiments of the present invention provide for a frame that covers a portion or all of the back and sides of the mobile device to further provide for a protective cover for the mobile device.

Yet further alternative embodiments provide for additional pivot points that allow for configuring the mobile device in a vertical or horizontal orientation to provide different viewing angles.

As will be readily appreciated from the foregoing summary, the invention provides a system, apparatus and method for manipulating, utilizing and supporting mobile electronic devices that incorporates a single integrated support element that efficiently and compactly attaches to the back of the device, may be used to protect as well as support the device in both vertical and horizontal orientations in a stable fashion, and can be set up and taken down in a single, simple movement.

### BRIEF DESCRIPTION OF THE DRAWINGS

Preferred and alternative embodiments of the present invention are described in detail below with reference to the following drawings.

FIGS. 1A-1D are perspective views of an exemplary mobile device and support system in accordance with an embodiment of the present invention showing vertical facing upwards, horizontal with a bottom end to the left, vertical upside down, and horizontal with a top end the left, respectively;

FIGS. 2A-2D are perspective views of a 4-way support system in accordance with an embodiment of the present invention showing exemplar retracted, vertical and horizontal orientations;

FIGS. 3A-3C are perspective views of an exemplar frame of the support system in accordance with an embodiment of the present invention showing ways in which pivots may be integrated into the frame;

FIGS. 4A and 4B are perspective views of a tongue-and-groove configuration of the pivots of the support system in accordance with an embodiment of the present invention;

FIGS. 5A and 5B are perspective views of a slider assembly configuration of the pivots of the support system in accordance with an embodiment of the present invention;

FIGS. 6A-6F are cross section views of a portion of the mobile device and support system in accordance with the present invention showing different embodiments of a temporary configuration for mounting the frame of the support system to the mobile device;

FIG. 7 is a perspective view of a portion of the mobile device and support system in accordance an embodiment of the present invention showing a mechanical connection using a pivot pin to connect the frame to the mobile device;

FIGS. 8A-8B are perspective views of the mobile device and support system in accordance with an embodiment of the present invention showing retainers used to connect the frame to the mobile device;

FIGS. 9A-9C are perspective views of the mobile device and support system in accordance with an embodiment of the present invention showing a mechanical connection using frictional contact along outer edges of the mobile device to connect the frame to the mobile device;

FIGS. 10A-10C are perspective views of the mobile device and support system in accordance with an embodiment of the present invention showing the support system as a protective cover of the mobile device extending to the back and sides of the device;

FIGS. 11A-11C are perspective views of a 2-way support system in accordance with an embodiment of the present invention;

FIGS. 12A-12D are perspective views of a five-way support system in accordance with an embodiment of the present invention;

FIGS. 13A-13B are elevated side views of the operation of the five-way support system shown in FIGS. 12A-12D in accordance with an embodiment of the present invention;

FIGS. 14A-14E are perspective views of the five-way support system in accordance with an alternative embodiment of the present invention;

FIGS. 15A-15B are cut-away, elevated side views of the operation of the five-way support system shown in FIGS. 14A-14E in accordance with an embodiment of the present invention; and

FIGS. 16A-16C are perspective views of the mobile device and support system in accordance with an embodiment of the present invention showing the support system as a protective cover of the mobile device extending to the back of the device.

### DETAILED DESCRIPTION OF THE PREFERRED EMBODIMENT

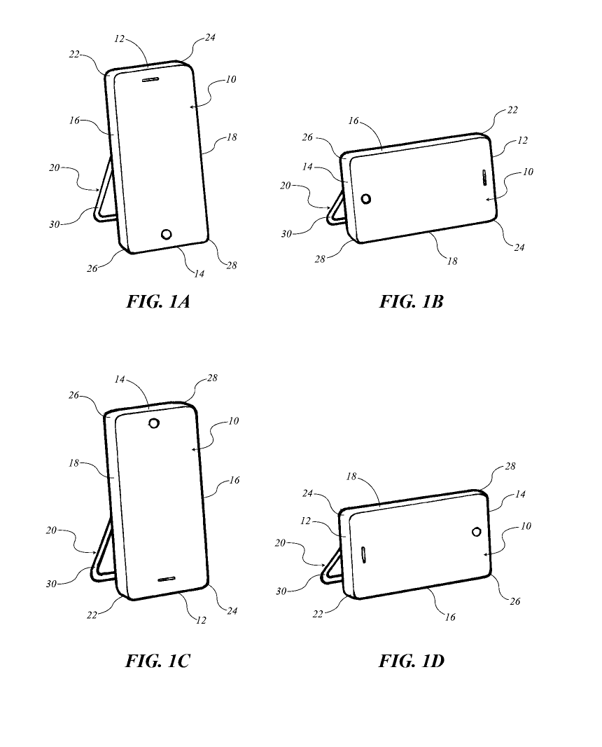

A system, apparatus and method for manipulating, utilizing and supporting mobile electronic devices that incorporates a single support element in a continuous frame configuration is disclosed. The preferred embodiment of the present invention utilizes multiple hinges or pivoting points to fold and unfold with one simple movement that provides support to electronic devices in both the vertical and horizontal orientations in a stable fashion. FIGS. 1A-1D illustrate an exemplary mobile device 10 and a support system 20 of the present invention. The mobile device 10 has a front typically including a viewing screen and a back, a top end 12, a bottom end 14, a left side 16 and a right side 18 together with four corners, namely, a top-left corner 22, a top-right corner 24, a bottom-left corner 26 and a bottom-right corner 28 formed at substantially a 90 degree angle at the intersection of the ends and sides of the mobile device. As used herein, mobile devices are meant to refer to and include any electronic device capable of ready transport and use, and include without limitation cellphones, smartphones, electronic readers, tablet computing devices, portable DVD and media players, and the like. For purposes of this application, reference to an exemplary mobile device will consistently reference these same features regardless of the precise nature, size, shape or configuration of the mobile device.

The support system 20 provides for stable configuration of the mobile device 10 in at least four different orientations, including vertical facing upwards (FIG. 1A), horizontal with the bottom end 14 to the left (FIG. 1B), vertical upside down (FIG. 1C) and horizontal with the top end 12 to the left (FIG. 1D). The support 20 is preferably configured such that it retracts within the footprint of the mobile device 10. In alternative embodiments describes below the support system 20 may be configured such that when retracted it is aligned with or sits along the outside of the top end 12, the bottom end 14, the left side 16 and the right side 18, or aligned with or along some portion thereof.

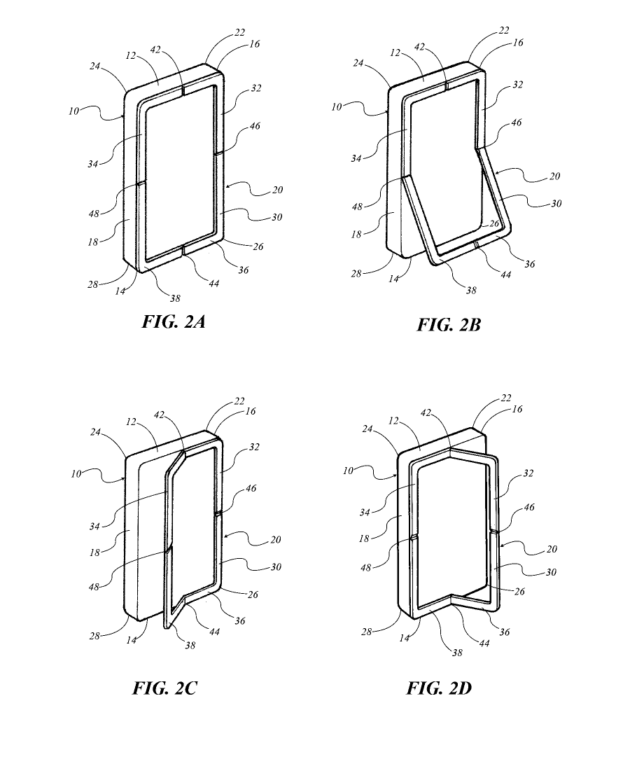

FIGS. 2A-2C illustrate a 4-way support system 20 of the present invention. In this embodiment, the support system 20 consists of a single or integrated continuous frame 30 preferably formed of a rigid material such as metal or plastic that substantially maintains its shapes notwithstanding repeated deformation, meaning that it is of sufficient strength and durability to retain its rectangular shape to support the mobile device in different orientations for a reasonable period of use. The frame 30 consists of four elements corresponding to the four corners of the mobile device 10: a top-left element 32 corresponding to and aligned with the top-left corner 22, a top-right element 34 corresponding to and aligned with the top-right corner 24, a bottom-left element 36 corresponding to and aligned with the bottom-left corner 26, and a bottom-right element 38 corresponding to and aligned with the bottom-right corner 28. These elements may be unitary parts of the frame or mechanically or otherwise connected to each other as part of the continuous frame. Each frame element 32-38 preferably is configured to substantially match the 90 degree angle of each corner 22-28 of the mobile device 10 and extend along the corresponding top, bottom or side of the mobile device to the adjoining element. For example, top-left element 32 extends from a substantially 90 degree bend corresponding to the top-left corner 22 along the top end 12 until it connects with the top-right element 34 and along the left side 16 until it connect with the bottom-left element 36, and so on for each element. As described in more detail below, the frame 30 may be attached to the mobile device 10 or an external protective cover such as a case, shell or holster (not shown) of the device in either a temporary or permanent configuration in a variety of different ways.

The point where each element connects with the adjoining element is a pivot point that are configured to bend so as to fold and unfold a portion of the frame 30 to provide for desired orientation of the mobile device 10. As illustrated in the embodiment of FIGS. 2A-2C, the four pivot points are placed along the top and bottom ends 12, 14 and the left and right sides 16, 18. Specifically, a top pivot 42 is located along the top end 12 connecting the top-left element 32 to the top-right element 34; a bottom pivot 44 is located along the bottom end 14 connecting the bottom-left element 36 to the top-right element 38; a left pivot 46 is located along the left side 16 connecting the top-left element 32 to the bottom-left element 36; a right pivot 48 is located along the right side 18 connecting the top-right element 34 to the bottom-right element 38.

The operation of the support system 20 is illustrated with reference to FIGS. 2A-2D in conjunction with FIGS. 1A-1D. The mobile device is supported by the support structure 20 of the present invention preferably when the mobile device is placed on a substantially flat surface, for example, a table or desk top, counter or cabinet, use lap or stomach, or other such surface. To position the mobile device 10 in a vertical orientation with the top end 12 facing upwards (FIG. 1A), bottom-left element 36 and bottom-right element 38 are pulled away from the mobile device 10, bending the frame 30 along left pivot 46 and right pivot 48, as shown in FIG. 2B. To position the mobile device 10 in a vertical orientation with the bottom end 14 facing upwards (FIG. 1C), top-left element 32 and top-right element 34 are pulled away from the mobile device 10, bending the frame 30 along left pivot 46 and right pivot 48 (not shown). To position the mobile device 10 in a horizontal orientation with the left side 16 facing upwards (FIG. 1B), top-right element 34 and bottom-right element 38 are pulled away from the mobile device 10, bending the frame 30 along top pivot 42 and bottom pivot 44, as shown in FIG. 2C. To position the mobile device 10 in a horizontal orientation with the right side 18 facing upwards (FIG. 1D), top-left element 32 and bottom-left element 36 are pulled away from the mobile device 10, bending the frame 30 along top pivot 42 and bottom pivot 44, as shown in FIG. 2D.

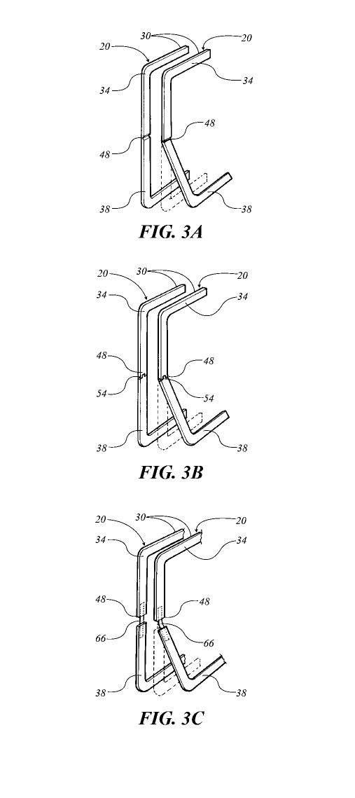

The pivots 42-48 may be integrated into the frame 30 in a number of different ways. FIGS. 3A-3C illustrate an exemplar section of the frame 30 showing the top-right element 34 and the bottom-right element 38 connected via right pivot 48. It will be appreciated that although a single example describing one of the several pivots is discussed, the same principals and functionality with respect to the pivots applies to each of the pivots found along the various elements 32-38 of the frame 30 of the present invention.

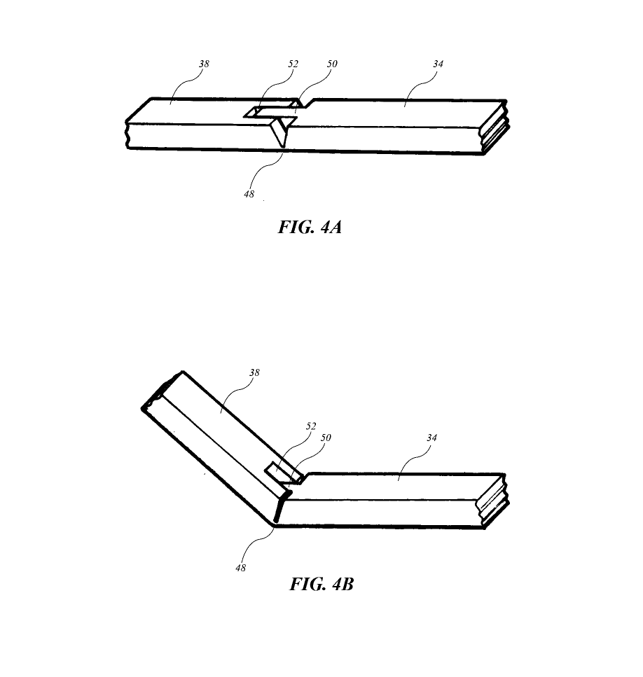

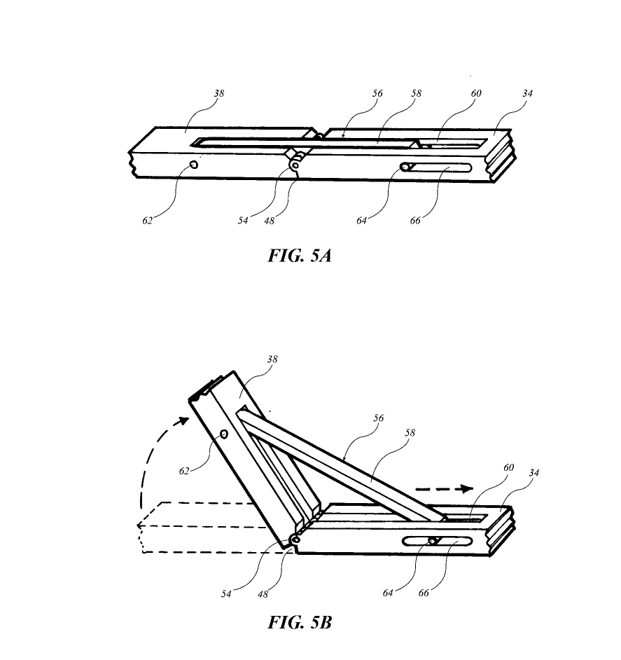

In FIG. 3A, the right pivot 48 is integrated into the frame 30 as a plastic or metal hinge, allowing movement of the bottom-right element 38 away from the mobile device 10 or protective case upon bending the hinge. In an alternative embodiment shown in FIGS. 4A and 4B, the integrated plastic or metal hinge of the right pivot 48 in a tongue-and-groove configuration wherein a tongue 50 is formed to fit into a corresponding groove 52. In FIG. 3B, the right pivot 48 is integrated into the frame 30 as a mechanical hinge utilizing a pivot pin 54 that rotatably connects the top-right element 34 and the bottom-right element 38, allowing movement of the bottom-right element 38 away from the mobile device 10 or protective case upon bending the hinge. In an alternative embodiment shown in FIGS. 5A and 5B, the mechanical hinge utilizing a pivot pin 54 further includes a slider assembly 56 having a slider shaft 58 formed to fit into a corresponding slider groove 60. The slider shaft 58 is pivotally connected to the top-right element 34 via stationary pin 62 and slidably connected to the bottom-right element 38 via slider pin 64. The slider assembly 56 facilitates bending movement of the bottom-right element 38 away from the mobile device 10 or protective case upon bending the right pivot 48. In FIG. 3C, the right pivot 48 is integrated into the frame 30 as a metal strip hinge utilizing a metal strip 66 or similar material band or strip movably affixed to or recessed within the top-right element 34 and the bottom-right element 38, allowing movement of the bottom-right element 38 away from the mobile device 10 or protective case upon bending the hinge.

The angle of the bend of the hinged pivot points 42-48 is configured to allow the 4-way support system 20 to maintain the mobile device 10 in the desired vertical or horizontal orientation. This may be accomplished in a number of ways, for example, by virtue of the strength of the frame 30 to maintain its shape despite bending or due to friction among system components. In the embodiment illustrated in FIG. 3A, this occurs as a function of the force of friction between the top-right element 34 and the bottom-right element 38 as these elements contact each other via right pivot 48. In the embodiment illustrated in FIGS. 4A-4B, this occurs as a function of the force of friction principally between the tongue 50 and groove 52 upon movement of the bottom-right element 38 away from the mobile device 10 or protective case upon bending the hinge. In the embodiment illustrated in FIG. 3B, this occurs as a function of the force of friction principally between the pivot pin 54 and the top-right element 34 and the bottom-right element 38 as these elements contact each other via right pivot 48. In the embodiment illustrated in FIGS. 5A-5B, this occurs as a function of the force of friction principally between the slider shaft 58 and the slider groove 60, or the slider pin 64 being tight-fit into the sliding groove 66, each method of which provides friction to maintain the bottom right element 38 in a configuration bending away from the mobile device 10 or protective case in any angle within a designated range upon movement of the bottom-right element 38 away from the mobile device 10 or protective case upon bending the hinge.

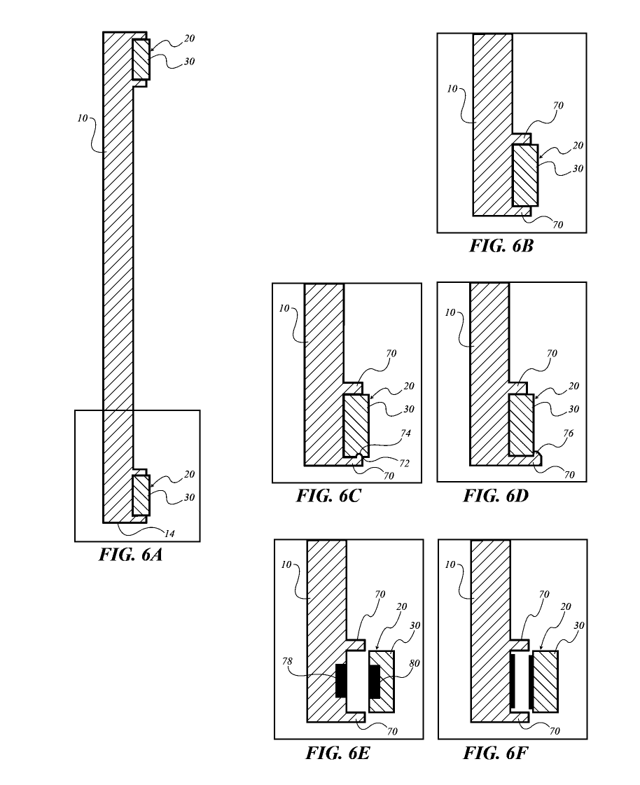

The frame 30 may be attached to the mobile device 10 or an external protective cover in either a temporary or permanent configuration in a variety of different ways, described in greater detail with reference to FIGS. 6A-6F. FIG. 6A illustrates a cross section of a portion of the mobile device 10 (or protective cover) showing the alignment of an exemplar frame 30 of the support system 20 of the present invention along the top end 12 and bottom end 14. It will be appreciated that the description of the methods of attachment applies similarly to other parts of the frame 30 as it pertains to other parts of the mobile device 10.

FIGS. 6B-6F illustrate different embodiments of a temporary configuration for mounting the frame 30 of the support system 20 to the mobile device. As illustrated in FIG. 6B, the mobile device 10 or protective cover may be formed with protrusions 70 corresponding in configuration to the frame 30, into which the frame 30 may be tightly fitted to secure the support system 20 to the mobile device or protective cover using the friction created between the protrusions 70 and the frame 30. As illustrated in FIG. 6C, at least one of the protrusions 70 on the mobile device 10 or protective cover may be formed with a tab 72 corresponding in configuration to a protrusion recess 74 formed along the frame 30. The frame 30 may be tightly fitted to secure the support system 20 to the mobile device or protective cover using the friction created between the protrusions 70 and the frame 30, further supported by the interaction of the tab 72 in the protrusion recess 74. As illustrated in FIG. 6D, at least one of the protrusions 70 on the mobile device 10 or protective cover may be formed with a lip 76 configured to overlap with the frame 30. The frame 30 may be tightly fitted to secure the support system 20 to the mobile device or protective cover using the friction created between the protrusions 70 and the frame 30, further supported by the interaction of the lip 76 restricting the movement of the frame 30. As illustrated in FIG. 6E, in addition to the protrusions 70 on the mobile device 10 or protective cover, magnetic attraction may be used to secure the frame 30. For example, a magnet or steel plate 78 formed into the mobile device or protective cover may be used to attract and secure the frame 30 having a corresponding magnet or steel plate 80. As illustrated in FIG. 6F, in addition to the protrusions 70 on the mobile device 10 or protective cover, a hook-and-loop assembly such as Velcro® may be used to secure the frame 30. For example, hook-and-loop may be placed both on the mobile device or protective cover and on the frame 30, allowing the frame 30 to be securely but removable affixed to the mobile device. In an alternative embodiment, one or more of the above embodiments may be used without the aid of protrusions formed into the mobile device 10 or protective cover. For example, the magnetic attraction or use of the hook-and-loop assembly may adequately secure the frame 30 of the support system 20 to the mobile device 10 or protective cover, allowing for stable operation of the present invention as described below.

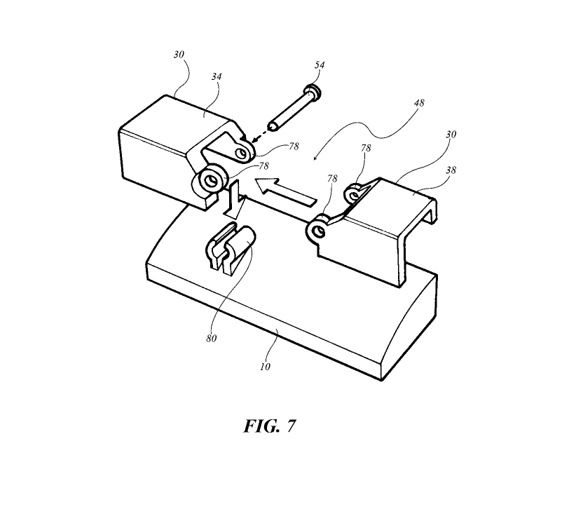

Yet further alternative embodiments providing for affixation of the frame 30 to the mobile device 10 or protective cover are shown with reference to FIGS. 7-10. FIG. 7A illustrates a mechanical connection utilizing a pivot pin 54 that is passed through mounting holes 78 integrally formed in the elements of the frame 30, for example, the top-right element 34 and the bottom-right element 38, in addition to securing mounting 80 of the mobile device 10 or protective cover. This provides a stable mounting of the frame 30 to the mobile device, while allowing for the pivoting movement of the pivots 42-48. The pivot pin 54 is maintained in place via frictional contact with the mounting holes 78 and securing mount 80.

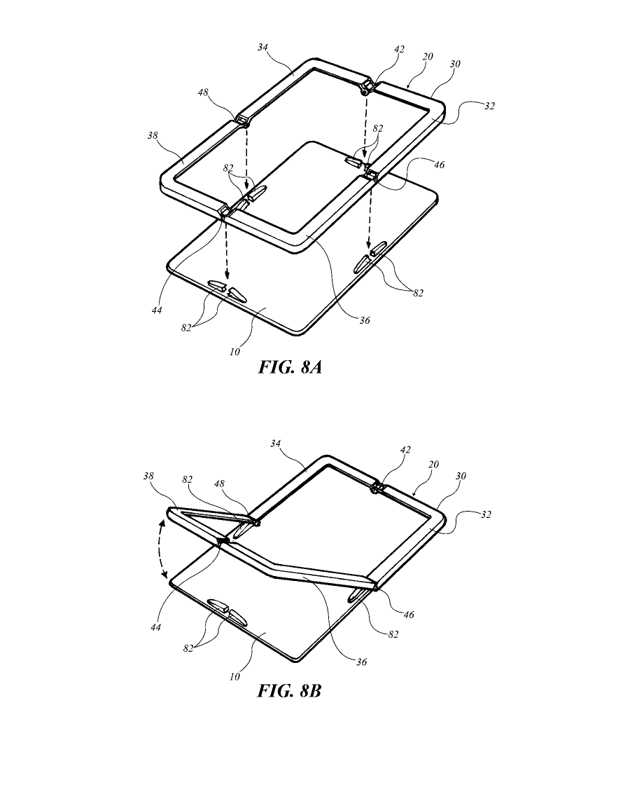

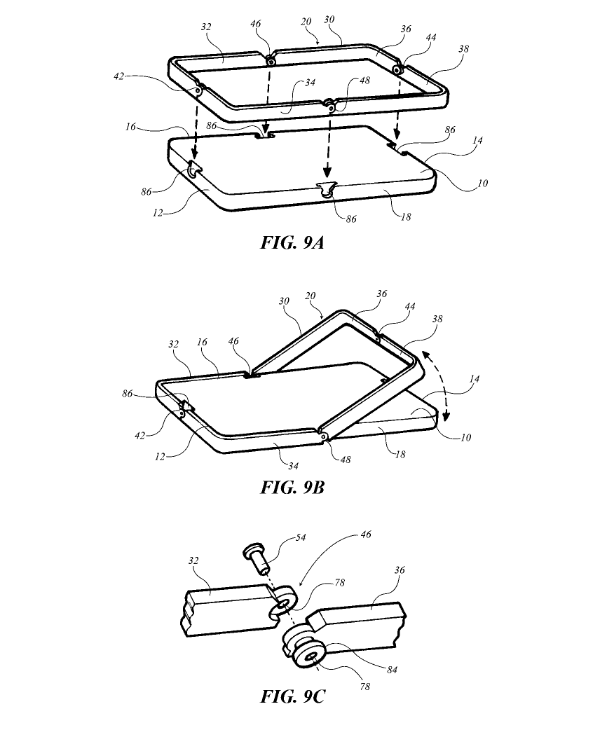

FIGS. 8A-8B illustrate a mechanical connection wherein preferably four retainers 82 are integrally formed in or otherwise affixed to the mobile device 10 or protective cover corresponding to the pivots 42-48 of the frame 30 and configured to receive and securing connect the frame 30 to the mobile device while allowing for continued pivotal movement of the elements 32-38 of the frame 30. FIGS. 9A-9C illustrate another mechanical connection in which the frame 30 mounts substantially outside the footprint of the mobile device 10, namely, along the outer edges of the top end 12, the bottom end 14, the left side 16 and the right side 18. The pivot pin 54 is maintained in place within mounting holes 78 formed in the frame 30 via frictional contact and further with the pivot pin cap 84, which is preferably frictionally fit with pivot pin 54. Pivot pin cap 84 is configured to snap-fit into corresponding snap recesses 86 formed in the mobile device 10 or protective cover along the top end 12, the bottom end 14, the left side 16 and the right side 18.

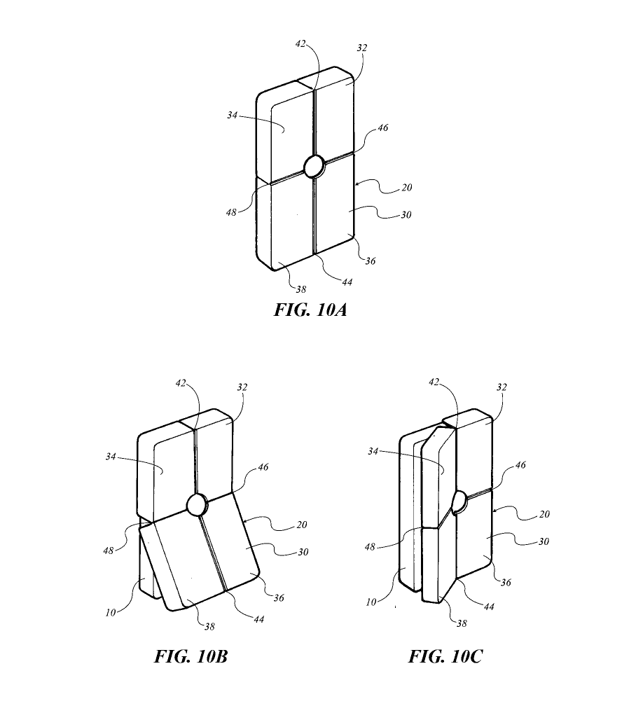

In yet another embodiment illustrated in FIGS. 10A-10C, the frame 30 is configured substantially as a protective cover or case. In this embodiment, the elements 32-38 are configured to cover and fit securely along a substantial portion of the back, top end 12, bottom end 14, left side 16 and right side 18 of the mobile device 10. Substantial portion is understood in the context of coverage of the back of sides to mean at least fifty percent of the back or sides. In this particular embodiment, substantial portion means more than fifty percent or the back and fifty percent of at least two of either the top and bottom or the sides of the mobile device. The frame 30 is held in place by frictional force between the frame 30 and the mobile device 10, or any of the methods described in FIGS. 6E, 6F and 7-9, while allowing for movement of the elements 32-38 along the pivots 42-48 in the same fashion as described above.

In an alternative embodiment where less than all of the orientations are desired, one element of the frame 30 may be permanently attached to the mobile device 10 or protective cover in variety of different way, for example, using screws, weld or glue. The frame may also be integrally formed with the mobile device or protective cover, for example, as discussed above with respect to the 2-way support system.

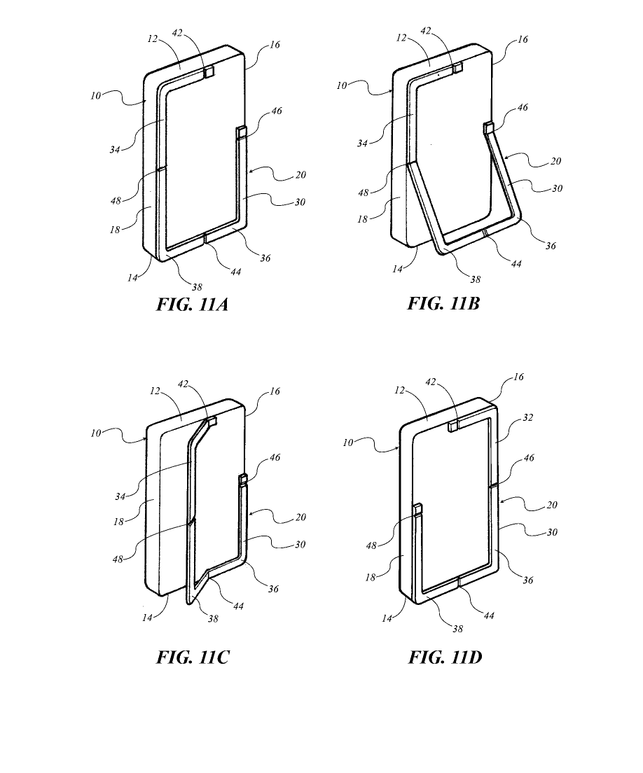

Alternative embodiments of the support system 20 of the present invention are described with reference to FIGS. 11-16. While four elements 32-38 of the frame 30 and four corresponding pivots 42-48 are typically preferred, alternative embodiments may include a different number of elements and corresponding pivots. Such variations allow for additional orientation adjustments and may be affixed in yet further additional ways. FIGS. 11A-11C illustrate a 2-way support system that provides for positioning of the mobile device 10 one of but not both the vertical facing upwards (FIG. 1A) and the vertical upside down (FIG. 1C) orientation, on the one hand, and the horizontal with the bottom end 14 to the left (FIG. 1B) and horizontal with the top end 12 to the left (FIG. 1D) orientations, on the other hand. In this embodiment, only three of the four elements 32-38 are used. In the example illustrated in FIGS. 11A-11C, only the top-right element 34, the bottom-right element 38 and the bottom-left element 36 are used, allowing for bending movement along the top pivot 42 and bottom pivot 44 or the left pivot 46 and the right pivot 48, respectively. FIG. 11D shows an alternative embodiment allowing for the same bending movement along the top pivot 42 and bottom pivot 44 or the left pivot 46 and the right pivot 48, respectively, but wherein only the top-left element 32, the bottom-right element 38 and the bottom-left element 36 are used. In this embodiment, the frame 30 may be permanently affixed to the mobile device 10 in place of a portion of the missing element (in this example the top-left element 32).

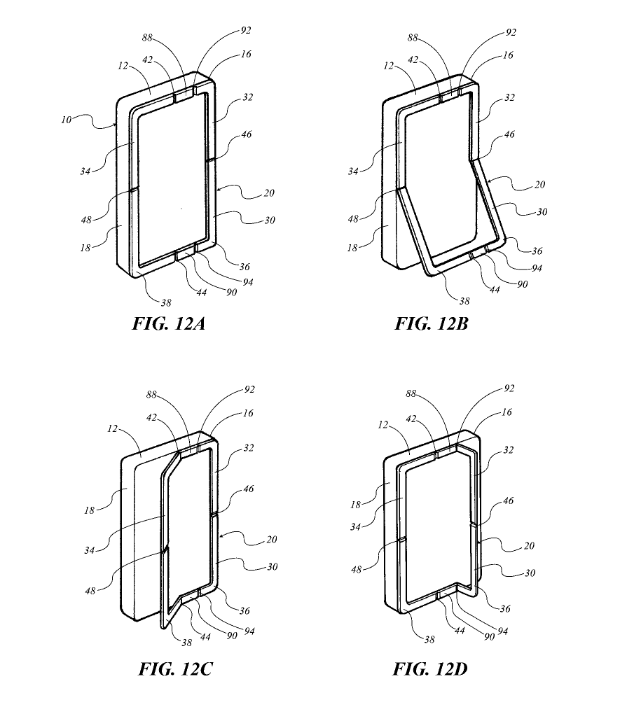

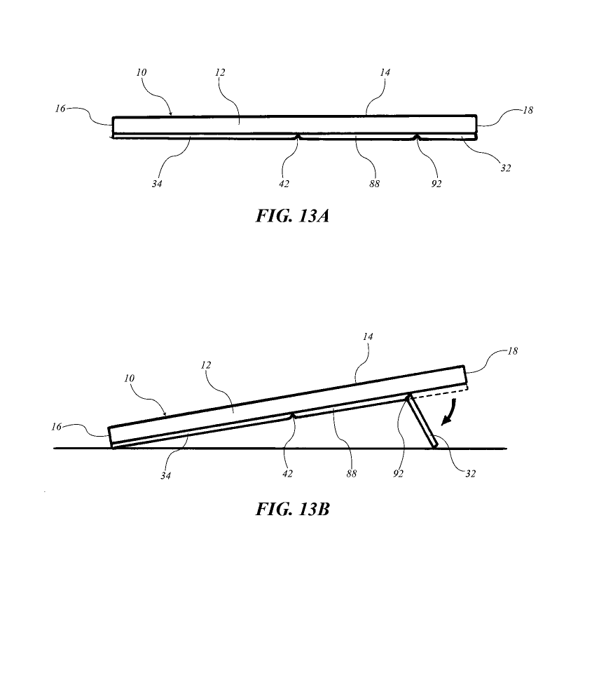

With reference to FIGS. 12A-12D, an alternative exemplary embodiment providing a five-way configuration is disclosed. In this embodiment, additional top-middle element 88 is formed between top-left element 32 and top-right element 34, preferably out of part of the top-left element 32 running along the top end 12. Additional bottom-middle element 90 is formed between bottom-left element 36 and bottom-right element 38, preferably out of part of the bottom-left element 36 running along the bottom end 14. An additional top-middle pivot 92 is located along the top end 12 connecting the top-left element 32 to the top-middle element 88, which in turn is connected to the top-right element 34 via the top pivot 42. An additional bottom-middle pivot 94 is located along the bottom end 14 connecting the bottom-left element 36 to the bottom-middle element 90, which in turn is connected to the bottom-right element 38 via the bottom pivot 44. As illustrated with further reference to FIGS. 13A-13B, in operation bending the frame 30 to move the top-left element 32 and the top-right element 34 away from the mobile device 10 along the top-middle pivot 92 and the bottom-middle pivot 94 creates a new orientation of the mobile device, in this example providing for horizontal viewing of the mobile device 10 at a lower level or, in other words, as a different viewing angle than provided when the combined top-left element 32, top-middle element 88, bottom-left element 36 and bottom-middle element 90 are moved away from the mobile device by bending the frame 30 along the top pivot 42 and bottom pivot 44 (not shown).

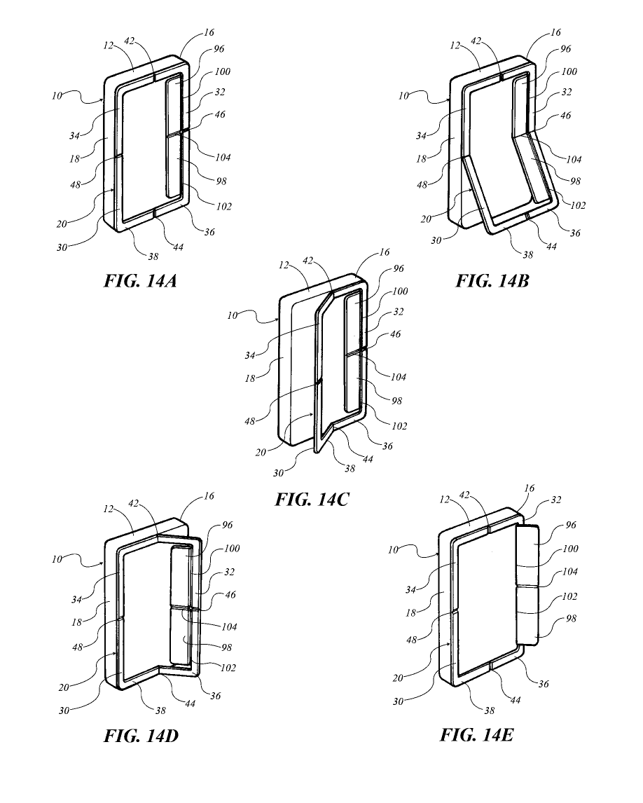

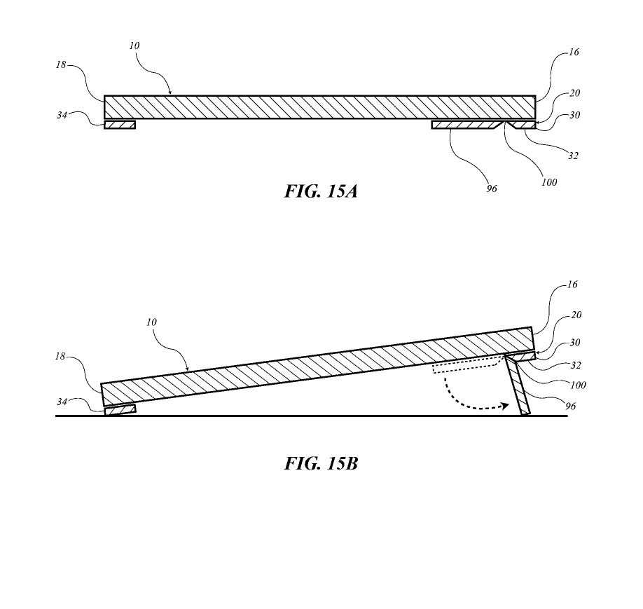

With reference to FIGS. 14A-14E, another alternative exemplary embodiment providing a five-way configuration is disclosed. In this embodiment, additional inner-top-left elements 96 of variable dimension is adjacent to top-left element 32 extending away from the left side 16 of the mobile device 10. Additional inner-bottom-left element 98 of variable dimension is adjacent to bottom-left element 36 extending away from the left side 16 of the mobile device 10. An additional inner-top-left pivot 100 is connecting the top-left element 32 to the inner-top-left elements 96. An additional inner-bottom-left pivot 102 is connecting the bottom-left element 36 to the inner-bottom-left elements 98. An additional middle pivot 104 connects the inner-top-left elements 96 to the inner-bottom-left element 98. As illustrated with further reference to sectional diagram FIGS. 15A-15B, in operation bending the frame 30 to move the inner-top-left element 96 and the inner-bottom-left element 98 away from the mobile device 10 along the inner-top-left pivot 100 and inner-bottom-left pivot 102 creates a new orientation of the mobile device, in this example again providing for horizontal viewing of the mobile device 10 at a lower level than provided when the combined top-left element 32, top-middle element 88, bottom-left element 36 and bottom-middle element 90 are moved away from the mobile device by bending the frame 30 along the top pivot 42 and bottom pivot 44 (not shown).

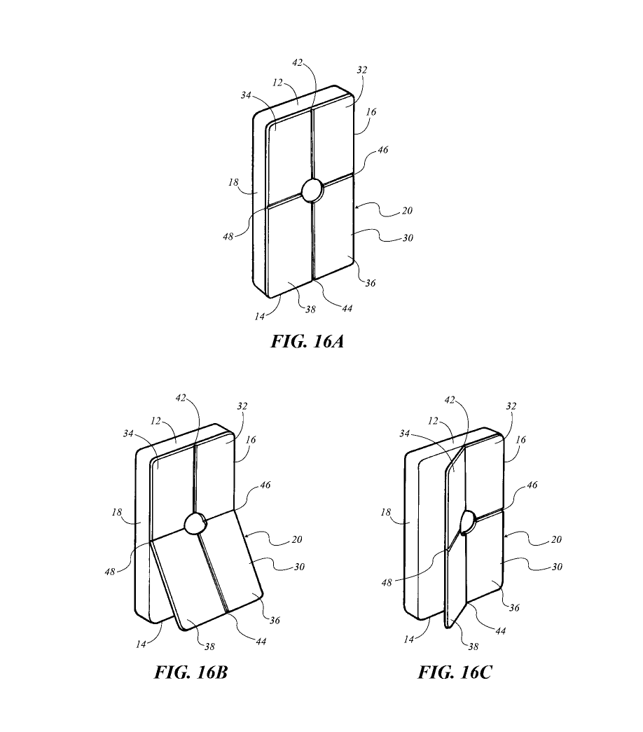

As described with reference to the embodiments illustrated in FIGS. 9 and 10, yet further variations integrate the elements 32-38 to function as a protective cover for the mobile device. FIGS. 16A-16C illustrate a 4-way support system that acts as a protective cover over the back of the mobile device 10 in addition to providing the support system functionality described above with reference to FIGS. 2A-2D. In this embodiment, the elements 32-38 cover a substantial portion of the back of the mobile device 10 and may be affixed to the device, for example, via magnetic attraction or hook-and-loop assembly as described above.

As described above, the present invention provides a system, apparatus and method for manipulating, utilizing and supporting mobile electronic devices that incorporates a single integrated support element that efficiently and compactly attaches to the back of the device, may be used to protect as well as support the device in both vertical and horizontal orientations in a stable fashion, and can be set up and taken down in a single, simple movement. The present invention may be applied to any mobile electronic device that utilizes a screen to provide for viewing in vertical or horizontal orientations. The disclosed support system 20 deploys with a simple movement that unfolds one or more elements 32-38 of the frame 30 into a stable configuration in which the mobile device 10 (with or without a protective cover) is able to stay erect in either a vertical or horizontal orientation. The support system 20 preferably affixes, either temporarily or permanently, to the back, sides or combination of back and sides of the mobile device 10. In the preferred embodiment the frame is detachable, and affixed to the mobile device via such means as friction, magnetic attraction or hook-and-loop assemblies. In a permanent configuration, screws, welding or glue to affix the frame may be used.

Each element 32-38 of the frame 30 preferable includes at least two anchor points, one on each end of the element, to freely allow movement of the elements at their pivots. The support system 20 pivots are preferably in pairs, each located symmetrically at the opposite sides of the frame 30. The preferred embodiment employs two pairs of pivots (four total pivots, e.g., the top pivot 42 and the bottom pivot 44 as one pair and the left pivot 46 and the right pivot 48 as another pair). An alternative describe embodiment employs three pairs of pivots (six total pivots, e.g., the top pivot 42 and the bottom pivot 44 as one pair, the left pivot 46 and the right pivot 48 as another pair, and the top-middle pivot 92 and the bottom-middle pivot 94 as another pair). Another alternative describe embodiment employs three pairs of pivots (six total pivots, e.g., the top pivot 42 and the bottom pivot 44 as one pair, the left pivot 46 and the right pivot 48 as another pair, and the inner-top-left pivot 100 and the inner-bottom-left pivot 102 as another pair).

In the preferred embodiments described above, the support system 20 is generally rectangular in shape corresponding to the typical shape of mobile devices. Preferable the frame 30 is parallel to the top end 12, the bottom end 14, the left side 16 and the right side 18 of the mobile device 10. The size of the frame 30 of the support system 20 is preferably approximately the same size and footprint of the mobile device 10, ideally within the thickness of the frame 30 so that when affixed, for example in the embodiment illustrated in FIGS. 2A-2D, there is substantially no protrusion of the frame beyond the edges of the mobile device. Contemplated variations of the size of the frame 30 include the following: the frame is smaller than the overall footprint of the device to allow at least a portion of the mobile device to extend outside the footprint of the frame; the frame has substantially the same footprint as the mobile device to allow the frame to be flush with the edges of the device; and the frame has a larger footprint than the mobile device to allow the frame to protrude beyond and perhaps wrap in whole or part around the edges of the mobile device.

The support system 20 preferably has a low profile such that the frame 30 rests substantially flat or with minimal protrusion when affixed to the back and/or sides of the mobile device when not in use. The thickness of the frame is preferably distributed substantially evenly at the back of the device, meaning that the thickness of the frame varies only slightly as compared to the various elements of the frame. In alternative embodiments, portions of the frame 30 may be modified by the addition or protrusions or other features that allow ready access and manipulation by the user to move the various elements of the frame. The preferred embodiments allow the user to deploy the support system 20 in a single movement that is both simple and ergonomic.

The preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. An apparatus for supporting a mobile electronic device in vertical and horizontal orientations, the mobile device having a front with a viewing screen, a back, a top end, a bottom end, a left side and a right side, comprising a single, continuous frame affixed to the mobile device having first, second, third and fourth pivots each located proximate to the top end, the bottom end, the left side and the right side, respectively, wherein the frame is configured bend away from the mobile device along the first and second pivot points and along the third and fourth pivot points.

2. The apparatus of claim 1, wherein the frame is affixed to the mobile device so as not to interfere with access to the front viewing screen.

3. The apparatus of claim 1, wherein the frame is affixed to the mobile device using frictional force between the frame and the mobile device.

4. The apparatus of claim 1, wherein the frame is affixed to the mobile device using magnetic attraction.

5. The apparatus of claim 1, wherein the frame is affixed to the mobile device using a hook-and-loop assembly.

6. The apparatus of claim 1, wherein the frame covers a substantial portion of the back of the mobile device.

7. The apparatus of claim 1, wherein the frame covers a substantial portion of at least two of the sides of the mobile device.

8. The apparatus of claim 1, wherein the frame covers a substantial portion of the back and sides of the mobile device.

9. The apparatus of claim 1, wherein the frame is made of rigid material.

10. The apparatus of claim 1, wherein the pivots are integrated into the frame using a pivot pin.

11. The apparatus of claim 1, wherein the pivots are integrated into the frame using a tongue-and-groove configuration.

12. The apparatus of claim 1, wherein the pivots are integrated into the frame using a metal strip hinge.

13. The apparatus of claim 1, wherein the pivots are integrated into the frame using a slider assembly.

14. The apparatus of claim 1, wherein the rigidity of the frame maintains its position away from the mobile device.

15. A system for supporting a mobile electronic device in vertical and horizontal orientations, the mobile device having a front with a viewing screen and a back, comprising:
a frame having first, second and third elements; and
first, second, third and fourth pivots, wherein the first pivot connects the first element to the frame, the second pivot connects the second and third elements, and the third pivot connects the third element to the frame and the fourth pivot connects the first and second elements or the third pivot connects the first and third elements and the fourth pivot connects the second element to the frame;
wherein the frame is affixed to the mobile device to allow for pivotal movement of the frame as follows:
if the third pivot connects the third element to the frame and the fourth pivot connects the first and second elements, movement of the first and second elements away from the back of the mobile device along the first and second pivots to facilitate maintaining the mobile device in a horizontal orientation when place on a viewing surface;
if the third pivot connects the first and third elements and the fourth pivot connects the second element to the frame, movement of the first and third elements away from the back of the mobile device along the first and second pivots to facilitate maintaining the mobile device in a horizontal orientation when place on a viewing surface; and
movement of the second and third elements away from the back of the mobile device along the third and fourth pivots to facilitate maintaining the mobile device in a vertical orientation when place on a viewing surface.

16. The system of claim 15, wherein the frame is affixed to the mobile device so as not to interfere with access to the front viewing screen.

17. The system of claim 15, wherein the frame is affixed to the mobile device using frictional force between the frame and the mobile device.

18. The system of claim 15, wherein the frame is affixed to the mobile device using magnetic attraction.

19. The system of claim 15, wherein the frame is affixed to the mobile device using a hook-and-loop assembly.

20. The system of claim 15, wherein the frame covers a substantial portion of the back of the mobile device.

21. The system of claim 15, wherein the frame covers a substantial portion of at least two of the sides of the mobile device.

22. The system of claim 15, wherein the frame covers a substantial portion of the back and sides of the mobile device.

23. The system of claim 15, wherein the frame is made of rigid material.

24. The system of claim 15, wherein the pivots are integrated into the frame using a pivot pin.

25. The system of claim 15, wherein the pivots are integrated into the frame using a tongue-and-groove configuration.

26. The system of claim 15, wherein the pivots are integrated into the frame using a metal strip hinge.

27. The system of claim 15, wherein the pivots are integrated into the frame using a slider assembly.

28. A system for supporting a mobile electronic device in vertical and horizontal orientations, the mobile device having a front with a viewing screen and a back, comprising:
a frame having first, second, third and fourth elements; and
first, second, third and fourth pivots movably connected between the frame elements, wherein the first pivot connects the first and second elements, the second pivot connects the third and fourth elements, the third pivot connect the first and fourth elements, and the fourth pivot connects the second and third elements;
wherein the frame is affixed to the mobile device to allow for pivotal movement of the frame as follows:
movement of the first and second elements away from the back of the mobile device along the third and fourth pivots to facilitate maintaining the mobile device in a vertical orientation when place on a viewing surface;
movement of the third and fourth elements away from the back of the mobile device along the third and fourth pivots to facilitate maintaining the mobile device in a vertical orientation when place on a viewing surface;
movement of the first and fourth elements away from the back of the mobile device along the first and second pivots to facilitate maintaining the mobile device in a horizontal orientation when place on a viewing surface; and
movement of the second and third elements away from the back of the mobile device along the first and second pivots to facilitate maintaining the mobile device in a horizontal orientation when place on a viewing surface.

29. The system of claim 28, wherein the frame is affixed to the mobile device so as not to interfere with access to the front viewing screen.

30. The system of claim 28, wherein the frame is affixed to the mobile device using frictional force between the frame and the mobile device.

31. The system of claim 28, wherein the frame is affixed to the mobile device using magnetic attraction.

32. The system of claim 28, wherein the frame is affixed to the mobile device using a hook-and-loop assembly.

33. The system of claim 28, wherein the frame covers a substantial portion of the back of the mobile device.

34. The system of claim 28, wherein the frame covers a substantial portion of at least two of the sides of the mobile device.

35. The system of claim 28, wherein the frame covers a substantial portion of the back and sides of the mobile device.

36. The system of claim 28, wherein the frame is made of rigid material.

37. The system of claim 28, wherein the pivots are integrated into the frame using a pivot pin.

38. The system of claim 28, wherein the pivots are integrated into the frame using a tongue-and-groove configuration.

39. The system of claim 28, wherein the pivots are integrated into the frame using a metal strip hinge.

40. The system of claim 28, wherein the pivots are integrated into the frame using a slider assembly.

41. The system of claim 28, wherein the frame further comprises fifth and sixth elements and fifth and sixth pivots;
the fifth pivot movably connects between the first and fifth elements and the sixth pivot movably connects between the fourth and sixth elements; and
the frame is affixed to the mobile device to allow for pivotal movement of the first and fourth elements away from the back of the mobile device along the fifth and sixth pivots to facilitate maintaining the mobile device in a horizontal orientation when place on a viewing surface.

42. The system of claim 28, wherein
the frame further comprises at least one additional element that movably connects between at least one of the first or fourth elements via a fifth pivot; and
the frame is affixed to the mobile device to allow for pivotal movement of the at least one additional element away from the back of the mobile device along the fifth pivot to facilitate maintaining the mobile device in a horizontal orientation when place on a viewing surface.
